(19) United States
(12) Patent Application Publication
(10) Pub. No.: US 2012/0194728 A1
(43) Pub. Date: Aug. 2, 2012

(54) IMAGE SENSOR MODULE AND CAMERA MODULE INCLUDING THE SAME

(75) Inventor: Young-sub KIM, Changwon-city (KR)

(73) Assignee: SAMSUNG TECHWIN CO., LTD., Changwon-city (KR)

(21) Appl. No.: 13/358,715

(22) Filed: Jan. 26, 2012

(30) Foreign Application Priority Data
Jan. 28, 2011 (KR) 10-2011-0008957

(51) Int. Cl. H04N 5/225

(52) U.S. Cl. 348/342; 348/E05.024

(57) ABSTRACT

Provided are an image sensor module, a camera module including the image sensor module, and a method of correcting a back focal length of a camera including the camera module. The image sensor module includes an image sensor which converts light into an electrical signal; an infrared ray filter which is configured to be movable between a first position in an optical path of the light entering the image sensor and a second position outside the optical path of the light entering the image sensor, and decreases an amount of infrared rays entering the image sensor if the infrared ray filter is at the first position; and a variable focus liquid crystal lens which is disposed in the optical path.

### CROSS-REFERENCE TO RELATED PATENT APPLICATION

This application claims priority from Korean Patent Application No. 10-2011-0008957 filed on Jan. 28, 2011 in the Korean Intellectual Property Office, the disclosure of which is incorporated herein in its entirety by reference.

### BACKGROUND

1. Field

Apparatuses and methods consistent with exemplary embodiments relate to an image sensor module in which an image sensor is arranged, and a camera module including the image sensor module.

2. Description of the Related Art

An image sensor detects both visible rays and infrared rays. In a case of daytime photography in which there is a sufficient amount of visible rays, infrared rays that enter the image sensor are generally blocked by using an infrared ray blocking filter.

On the other hand, in an environment where light is insufficient, e.g., nighttime photography, the amount of visible rays is insufficient so that infrared rays have to be used in photographing. Thus, it is necessary to exclude the infrared ray blocking filter.

In a case of a photographing apparatus, e.g., a surveillance camera, that continuously performs photographing, the photographing apparatus may include an infrared ray blocking filter that is movable so as to be disposed in front of an image sensor in the daytime and to be disposed away from a front side of the image sensor in the nighttime. An example of a photographing apparatus including a movable infrared ray blocking filter is disclosed in Japanese Patent Publication No. 3861241.

However, in the photographing apparatus including the movable infrared ray blocking filter, the infrared ray blocking filter is in and out of an optical path of light that enters an image sensor, by which a back focal length is changed. Thus, an image is not focused due to the movement of the infrared ray blocking filter.

In order to address the aforementioned problem, a camera module disclosed in Japanese Patent Publication No. 3861241 includes a mechanical mechanism for changing a distance between a lens and an image sensor. However, due to the complicated mechanical mechanism, the camera module disclosed in Japanese Patent Publication No. 3861241 is difficult to be assembled, is difficult to be compact, and is weak to shock.

### SUMMARY

One or more exemplary embodiments provide an image sensor module and a camera module, which have simple structures and are advantageous for compactness, whereby daytime photography and nighttime photography may be smoothly performed.

One or more exemplary embodiments also provide a method of adjusting a back focal length of a camera, whereby the back focal length of the camera may be efficiently controlled without a complicated mechanical mechanism.

According to an aspect of an exemplary embodiment, there is provided an image sensor module including an image sensor which converts light into an electrical signal; an infrared ray filter which is configured to be movable between a first position in an optical path of the light entering the image sensor and a second position outside the optical path of the light entering the image sensor, and decreases an amount of infrared rays entering the image sensor if the infrared ray filter is at the first position; and a variable focus liquid crystal lens which is disposed in the optical path.

The image sensor module may further include a dummy filter which is at the first position if the infrared ray filter is at the second position, and is outside the optical path if the infrared ray filter is at the first position, wherein the dummy filter transmits visible rays and infrared rays.

The image sensor module may further include a frame that is disposed to be movable in a direction crossing the optical path, and the infrared ray filter and the dummy filter may be included in the frame.

The image sensor module may further include a rotational movement body which has a rotational center axis line in a direction substantially parallel with the optical path, and has a portion which is positioned at the first position or the second position as the rotational movement body rotates, wherein the infrared ray filter is disposed at the portion of the rotational movement body.

The image sensor module may further include a dummy filter which is disposed at another portion of the rotational movement body, whereby one of the dummy filter and the infrared ray filter is disposed at the first position according to the rotation of the rotational movement body.

The image sensor module may further include comprising an additional filter that is disposed at still another portion of the rotational movement body, whereby one of the dummy filter, the infrared ray filter and the additional filter is disposed at the first position according to the rotation of the rotational movement body, wherein the additional filter is configured to block light having a given wavelength or has a smaller infrared blocking index than the infrared ray filter to block a portion of infrared rays.

The additional filter may have a smaller infrared blocking index than the infrared ray filter.

According to an aspect of another exemplary embodiment, there is provided a camera module including the image sensor module and a lens which may be combined with the image sensor module.

The camera module may also include a rotational movement body which has a rotational center axis line in a direction substantially parallel with the optical path, and has a portion which is positioned at the first position or the second position as the rotational movement body rotates. The camera module may further include a dummy filter which is disposed at another portion of the rotational movement body, whereby one of the dummy filter and the infrared ray filter is disposed at the first position according to the rotation of the rotational movement body. The camera module may further include an additional filter which is disposed at still another portion of the rotational movement body, whereby one of the dummy filter, the infrared ray filter and the additional filter is disposed at the first position according to the rotation of the rotational movement body.

The additional filter may have a smaller infrared blocking index than the infrared ray filter.

According to an aspect of still another exemplary embodiment, there is provided a method of correcting a back focal length of a camera, the method including allowing an infrared ray filter to be disposed in or outside an optical path of incident light which enters an image sensor, wherein the infrared ray filter decreases am amount of an infrared ray comprised in the incident light; and if a focus of the incident light is changed as the infrared ray filter is disposed in or outside the optical path, adjusting a focal length of the incident light by changing a focal length of a variable focus liquid crystal lens disposed in the optical path of the incident light, whereby the focus of the incident light is positioned on the image sensor.

### BRIEF DESCRIPTION OF THE DRAWINGS

The above and other aspects will become more apparent by describing in detail exemplary embodiments with reference to the attached drawings, in which:

FIG. 1 is a cross-sectional view of an image sensor module, according to an exemplary embodiment;

FIG. 2 is a perspective view that schematically illustrates a structure of a portion of the image sensor module in FIG. 1, according to an exemplary embodiment;

FIG. 3 is a cross-sectional view that schematically illustrates an operational state of a camera module including the image sensor module of FIG. 1, according to an exemplary embodiment;

FIG. 4 is a cross-sectional view that schematically illustrates another operational state of the camera module of FIG. 3, according to an exemplary embodiment; and

FIG. 5 is a perspective view that schematically illustrates an image sensor module according to another exemplary embodiment.

### DETAILED DESCRIPTION OF THE EXEMPLARY EMBODIMENTS

Hereinafter, an image sensor module and a camera module including the image sensor module according to one or more exemplary embodiments will be described in detail with reference to the attached drawings.

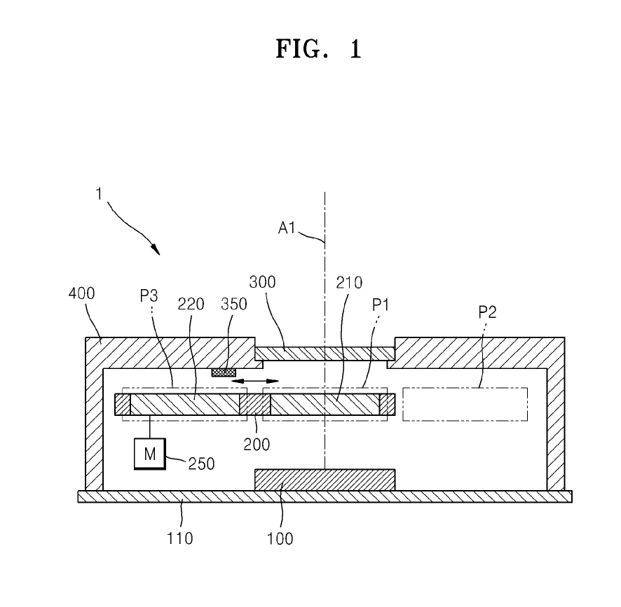

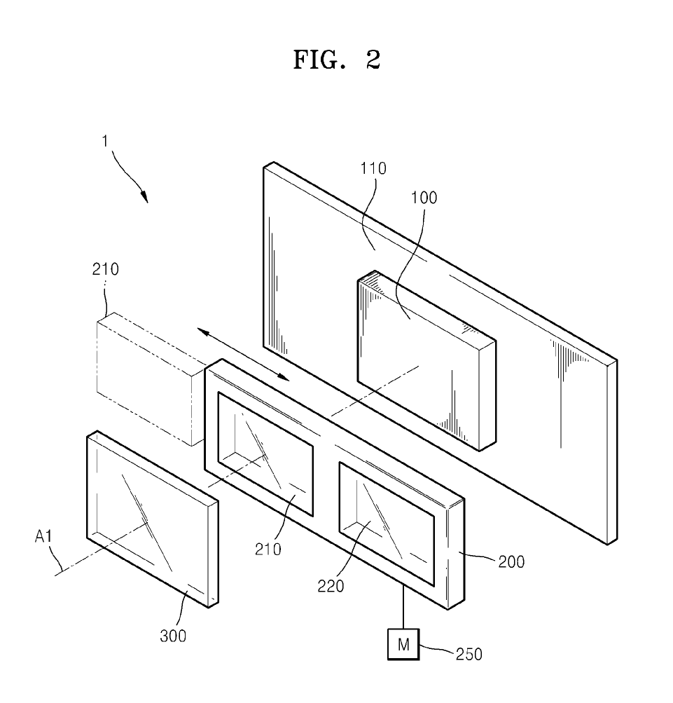

FIG. 1 is a cross-sectional view of an image sensor module 1 according to an exemplary embodiment. FIG. 2 is a perspective view that schematically illustrates a structure of a portion of the image sensor module 1 in FIG. 1.

Referring to FIGS. 1 and 2, the image sensor module 1 according to the present embodiment includes a housing 400, a substrate 110, an image sensor 100, a frame 200, a driving unit 250, an infrared ray filter 210, a dummy filter 220, a variable focus liquid crystal lens 300, and a controller 350.

The housing 400 provides a space in which the substrate 110, the image sensor 100, the frame 200, the driving unit 250, the infrared ray filter 210, the variable focus liquid crystal lens 300, and the dummy filter 220 may be disposed. Also, the housing 400 may function to protect inner configuring elements from foreign substances or external shock.

The substrate 110 is a portion on which the image sensor 100 is mounted, and may be formed as a printed circuit board (PCB) or a flexible PCB.

The image sensor 100 receives light and converts the light into an electrical signal, and may be formed as a charge-coupled device (CCD) or a complementary metal-oxide semiconductor (CMOS).

The frame 200 is disposed in a front side of a light-receiving surface of the image sensor 100, and is configured to reciprocate in a direction crossing an optical path A1 of light that enters the image sensor 100. For the frame 200 to be movable, the frame 200 may be slidably attached to an inner surface of the housing 400 or may be slidabley attached to slide on a top surface of the substrate 110. However, the position of the frame 200 is not limited to the above.

The driving unit 250 functions to control movement of the frame 200, and may include various types of actuators including a servo motor, a voice coil motor (VCM), and the like. Also, the driving unit 250 may include a gear system for delivering a driving force of the various types of actuators to the frame 200.

The infrared ray filter 210 is disposed in the frame 200, and functions to decrease a transmission amount of infrared rays. According to the movement of the frame 200, the infrared ray filter 210 may reciprocate between a first position P1 in the optical path A1 of light entering the image sensor 100, and a second position P2 outside the optical path A1 of light entering the image sensor 100. That is, when the infrared ray filter 210 is at the first position P1, the amount of infrared rays entering the image sensor may be effectively reduced.

The dummy filter 220 and the infrared ray filter 210 are disposed together in the frame 200, and the dummy filter 220 transmits both visible rays and infrared rays. The dummy filter 220 is disposed in the frame 200, so that, when the infrared ray filter 210 is at the second position P2, the dummy filter 220 is at the first position P1, and when the infrared ray filter 210 is at the first position P1, the dummy filter 220 is at a third position P3 outside the optical path A1. These position changes between the infrared ray filter 210 and the dummy filter 220 are controlled by the driving unit 250. When the dummy filter 220 is at the first position P1, both visible rays and infrared rays may enter the image sensor 100.

The variable focus liquid crystal lens 300 is a lens of which a refractive index varies according to variation of orientation of liquid crystal molecules, and may change its focal length by control of the controller 350 to apply a voltage between both terminals of the variable focus liquid crystal lens 300.

The variable focus liquid crystal lens 300 is disposed at the optical path A1, and is fixed to the housing 400. That is, light passes through the variable focus liquid crystal lens 300 before the light enters the image sensor 100.

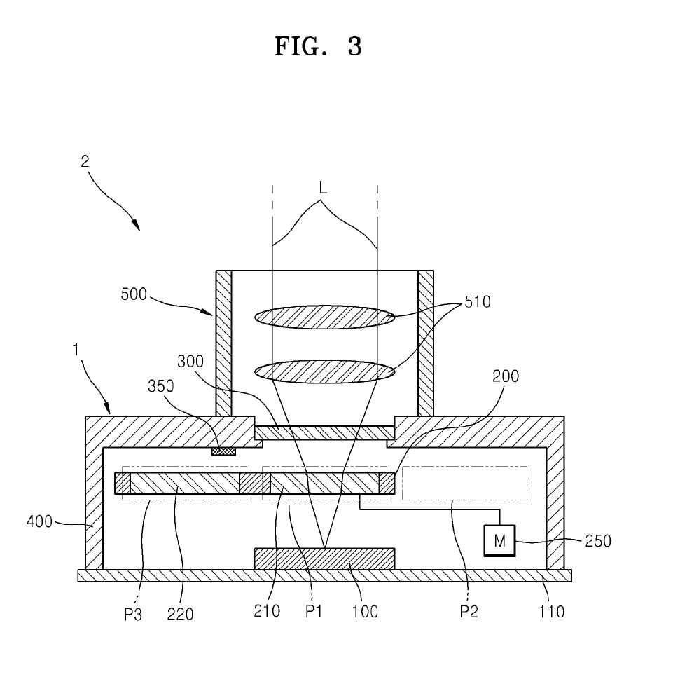

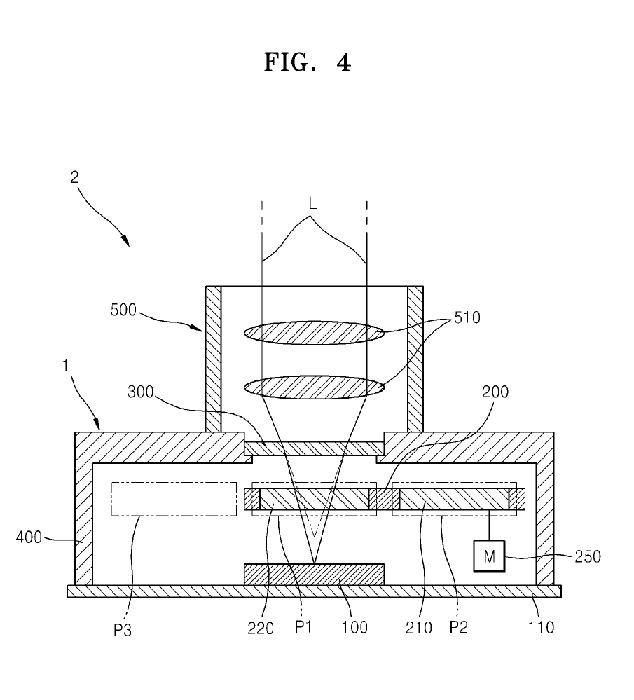

Next, a method of driving the image sensor module 1 will now be described with reference to FIGS. 3 and 4.

FIG. 3 is a cross-sectional view that schematically illustrates an operational state of a camera module 2 including the image sensor module 1 of FIG. 1, according to an exemplary embodiment. FIG. 4 is a cross-sectional view that schematically illustrates another operational state of the camera module 2 of FIG. 3, according to an exemplary embodiment.

Referring to FIGS. 3 and 4, the camera module 2 includes the image sensor module 1 of FIG. 1 and a lens barrel 500 connected to the image sensor module 1.

The lens barrel 500 may be fixed to the image sensor module 1 or may be detachable from the image sensor module 1 to be separated and replaced.

FIG. 3 schematically illustrates the operational state of the camera module 2 in daytime photography. As illustrated in FIG. 3, in the daytime photography, the infrared ray filter 210 is at the first position P1 and the dummy filter 220 is at the third position P3. Thus, light that enters the lens barrel 500 passes through a lens 510, the variable focus liquid crystal lens 300, and the infrared ray filter 210, and then, reaches the image sensor 100. Here, in order to allow a focus of incident light L entering the lens barrel 500 to be positioned on the image sensor 100, focal lengths of the lens 510 and the variable focus liquid crystal lens 300 are appropriately adjusted.

As illustrated in FIG. 3, when the infrared ray filter 210 is at the first position P1, an infrared ray component of the incident light L entering the lens barrel 500 is blocked. Thus, only a visible ray component of the incident light L enters the image sensor 100, so that it is possible to capture an image having colors similar to colors seen with the naked eyes.

In nighttime photography, the amount of visible rays is insufficient. Thus, in order to obtain a recognizable image, it is necessary to sense light in an infrared ray area by using the image sensor 100. Thus, it is required to move the infrared ray filter 210, which is in the optical path A1 of light entering the image sensor 100, outside the optical path A1. Moving the infrared ray filter 210 and the dummy filter 220 among the first through third positions is controlled by the driving unit 250 automatically or manually. For automatic control, the driving unit 250 may obtain a signal from the image sensor 100 or a separate sensor (not shown) to determine change of an amount of light entering the image sensor 100 or the separate sensor. For example, the daytime changes to the nighttime, the driving unit 250 may control the frame 200 such that the infrared ray filter 210 is at the second position P2 and the dummy filter 220 is at the first position P1.

FIG. 4 schematically illustrates the operational state of the camera module 2 in the nighttime photography. Referring to FIG. 4, the infrared ray filter 210 moves to the second position P2, and thus, is outside the optical path A1. Then, the dummy filter 220 is at the first position P1 in the optical path A1.

Since the dummy filter 220 transmits both visible rays and infrared rays, incident light L that enters the lens barrel 500 passes through the lens 510, the variable focus liquid crystal lens 300, and the dummy filter 220, and then, reaches the image sensor 100. Thus, the image sensor 100 may sense both visible rays and infrared rays, thereby generating a recognizable image in an environment where the amount of visible rays is insufficient.

Thicknesses or refractive indexes of the dummy filter 220 and the infrared ray filter 210 may be different. Thus, if the dummy filter 220 is at the first position P1, a focus of the incident light L may deviate from the image sensor 100 as illustrated in FIG. 4 using a dotted line. As such, an image obtained via the image sensor 100 may be blurry.

This problem may be addressed by changing the refractive index of the variable focus liquid crystal lens 300 by controlling a voltage between both terminals of the variable focus liquid crystal lens 300. That is, by controlling a focal length of the variable focus liquid crystal lens 300, it is possible to focus the incident light L correctly on the image sensor 100.

According to the related art, there was an attempt to maintain the focus of the incident light L on the image sensor 100 by appropriately selecting the thickness or the refractive index of the dummy filter 220, although the dummy filter 220, instead of the infrared ray filter 210, is at the first position P1. However, it was very difficult to exactly control the thickness or the refractive index of the dummy filter 220, so that there still remains the problem that the focus of the incident light L deviates. However, according to the image sensor module 1 and the camera module 2 of the present embodiment, the problem of deviation of the focus may be efficiently removed, regardless of variation or an error with respect to the thickness or the refractive index of the dummy filter 220.

In order to minimize focus control of the variable focus liquid crystal lens 300, the thickness and the refractive index of the dummy filter 220 may be adaptively set to decrease the deviation of the focus which may occur when the dummy filter 220, instead of the infrared ray filter 210, is at the first position P1.

As described above, by using the camera module 2, daytime photography and nighttime photography may be smoothly performed, and by using the variable focus liquid crystal lens 300, a focus of an image may not deviate although the infrared ray filter 210 moves.

In particular, unlike a camera module disclosed in Japanese Patent Publication No. 3861241, the camera module 2 according to the present embodiment may focus the incident light L exactly on the image sensor 100 without mechanically changing a back focal length.

Thus, compared to the related art, the camera module 2 according to the present embodiment has a simple mechanical mechanism so that the camera module 2 is easily assembled, and is highly advantageous for compactness.

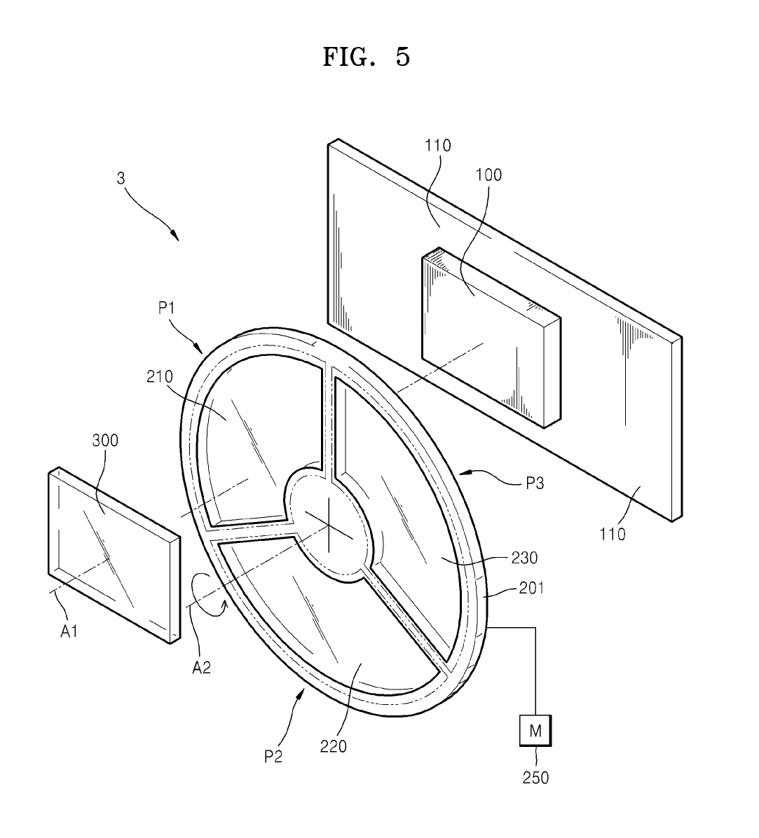

Next, an image sensor module 3 according to another exemplary embodiment will be described with reference to FIG. 5.

FIG. 5 is a perspective view that schematically illustrates the image sensor module 3 according to another exemplary embodiment.

Referring to FIG. 5, the image sensor module 3 includes the substrate 110, the image sensor 100, a rotational movement body 201, the infrared ray filter 210, the dummy filter 220, an additional filter 230, and the variable focus liquid crystal lens 300. Also, although not illustrated in FIG. 5, the image sensor module 3 may further include the housing 400 in which the substrate 110 and the rotational movement body 201 may be disposed.

The substrate 110, the image sensor 100, and the variable focus liquid crystal lens 300 are the same as those of the image sensor module 1 in FIG. 1, and thus, detailed descriptions thereof are omitted here.

The rotational movement body 201 has a rotational center axis line A2 in a direction parallel with an optical path A1 of light that enters the image sensor 100, and a portion of the rotational movement body 201 is in the optical path A1. Thus, according to rotation of the rotational movement body 201, the portion of the rotational movement body 201 may move between a first position P1 in the optical path A1 of light that enters the image sensor 100, and a second position P2 outside the optical path A1.

Referring to FIG. 5, according to the rotation of the rotational movement body 201, the portion of the rotational movement body 201 may move not only to the first position P1 and the second position P2 but also to a third position P3 that is outside the optical path A1 and is different from the second position P2. That is, according to the rotation of the rotational movement body 201, the portion of the rotational movement body 201 may rotatably move among the first position P1, the second position P2, and the third position P3.

The infrared ray filter 210 decreases a transmission amount of infrared rays, and is disposed as the portion of the rotational movement body 201, which may move among the first position P1, the second position P2, and the third position P3. That is, according to the rotation of the rotational movement body 201, the infrared ray filter 210 may be at one of the first position P1, the second position P2, and the third position P3 while the infrared ray filter 210 moves in a direction crossing the optical path A1. When the infrared ray filter 210 is at the first position P1, an infrared ray component of light entering the image sensor 100 is blocked.

The dummy filter 220 transmits both visible rays and infrared rays, and the dummy filter 220 and the infrared ray filter 210 are disposed together in the rotational movement body 201. The dummy filter 220 is disposed in the rotational movement body 201 in such a manner that the dummy filter 220 moves among the first position P1, the second position P2, and the third position P3 according to the rotation of the rotational movement body 201. Referring to FIG. 5, when the infrared ray filter 210 is at the first position P1, the dummy filter 220 is at the second position P2, and when the infrared ray filter 210 is at the second position P2, the dummy filter 220 is at the third position P3.

The additional filter 230 has a filtering characteristic different from the infrared ray filter 210 and the dummy filter 220, and is arranged at an environment that is not appropriate for the infrared ray filter 210 or the dummy filter 220. For example, the additional filter 230 may be arranged for a transitional environment in which the daytime changes to the nighttime, i.e., at dusk. The additional filter 230 may block only light having a particular wavelength or may have a smaller infrared blocking index than the infrared ray filter to block only a portion of infrared rays.

The additional filter 230, the infrared ray filter 210, and the dummy filter 220 may be disposed together in the rotational movement body 201. The additional filter 230 may also move among the first position P1, the second position P2, and the third position P3 according to the rotation of the rotational movement body 201. Referring to FIG. 5, when the infrared ray filter 210 is at the first position P1, the additional filter 230 is at the third position P3, and when the infrared ray filter 210 is at the second position P2, the additional filter 230 is at the first position P1.

The driving unit 250 functions to rotate the rotational movement body 201, and may include a motor.

As described above, the image sensor module 3 according to the present embodiment may dispose the infrared ray filter 210 at one of the first position P1, the second position P2, and the third position P3 by rotating the rotational movement body 201 by controlling the driving unit 250. That is, in daytime photography, the image sensor module 3 may dispose the infrared ray filter 210 at the first position P1, and in nighttime photography, the image sensor module 3 may dispose the infrared ray filter 210 at the second position P2 or the third position P3. By doing so, it is possible to efficiently perform photographing regardless of whether it is daytime or nighttime.

Also, the image sensor module 3 according to the present embodiment further includes the additional filter 230, thereby effectively preparing for another environment that is neither daytime nor nighttime.

Since the infrared ray filter 210, the dummy filter 220, or the additional filter 230 is rotatably disposed at the first position P1, a position of a focus of incident light may be changed. In this regard, since the image sensor module 3 includes the variable focus liquid crystal lens 300, the image sensor module 3 may exactly focus the incident light on the image sensor 100, regardless of the type of filter disposed at the first position P1.

In the above description, it is described that the image sensor modules 1 and 3 include the dummy filter 220. However, an image sensor module may not include the dummy filter 220. That is, a portion in which the dummy filter 220 is included in the frame 200 or the rotational movement body 201 of the image sensor modules 1 and 3, respectively, may be an empty space.

Also, although it is described that the image sensor module 1 of FIG. 1 includes only the infrared ray filter 210 and the dummy filter 220, the image sensor module 1 of FIG. 1 may further include the additional filter 230 as in the image sensor module 3 of FIG. 5.

Also, with respect to the image sensor modules 1 and 2 according to the embodiments, it is described that the variable focus liquid crystal lens 300 is disposed in front of the infrared ray filter 210 and the dummy filter 220. However, the variable focus liquid crystal lens 300 may be disposed anywhere in the optical path A1 of light that enters the image sensor 100. That is, the variable focus liquid crystal lens 300 may be disposed at a rear side of the infrared ray filter 210 and the dummy filter 220, or may be disposed between the lenses 510 of the camera module 2.

According to the image sensor module and the camera module of the one or more embodiments, daytime and nighttime photography may be smoothly performed, and the image sensor module and the camera module are highly advantageous for a simple structure and compactness.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

1. An image sensor module comprising:
an image sensor which converts light into an electrical signal;
an infrared ray filter which is configured to be movable between a first position in an optical path of the light entering the image sensor and a second position outside the optical path of the light entering the image sensor, and decreases an amount of infrared rays entering the image sensor if the infrared ray filter is at the first position; and
a variable focus liquid crystal lens which is disposed in the optical path.

2. The image sensor module of claim 1, further comprising a dummy filter which is at the first position if the infrared ray filter is at the second position, and is outside the optical path if the infrared ray filter is at the first position,
wherein the dummy filter transmits visible rays and infrared rays.

3. The image sensor module of claim 2, further comprising a controller which controls a voltage applied to the variable focus liquid crystal lens to change a focal length by changing a refractive index thereof.

4. The image sensor module of claim 3, wherein the controller controls the voltage applied to the variable focus liquid crystal lens to change the focal length by changing the refractive index thereof if the dummy filter is at the first position, and the controller does not control the voltage applied to the variable focus liquid crystal lens to change the focal length by changing the refractive index thereof if the infrared filter is at the first position.

5. The image sensor module of claim 4, further comprising a driving unit which moves the infrared ray filter and the dummy filter between the first position and the second position by determining an amount of the light entering the image sensor.

6. The image sensor module of claim 4, further comprising an additional filter which is disposed at a third position if the infrared ray filter and the dummy filter are at the first and second positions or the second and first positions, respectively,
wherein the driving unit disposes one of the dummy filter, the infrared ray filter and the additional filter is disposed at the first position by determining an amount of the light entering the image sensor,
wherein the additional filter is configured to block light having a given wavelength or has a smaller infrared blocking index than the infrared ray filter to block a portion of infrared rays.

7. The image sensor module of claim 2, further comprising a frame that is disposed to be movable in a direction crossing the optical path, wherein the infrared ray filter and the dummy filter are comprised in the frame.

8. The image sensor module of claim 1, further comprising a rotational movement body which has a rotational center axis line in a direction substantially parallel with the optical path, and has a portion which is positioned at the first position or the second position as the rotational movement body rotates,
wherein the infrared ray filter is disposed at the portion of the rotational movement body.

9. The image sensor module of claim 8, further comprising a dummy filter which is disposed at another portion of the rotational movement body, whereby one of the dummy filter and the infrared ray filter is disposed at the first position according to the rotation of the rotational movement body.

10. The image sensor module of claim 9, further comprising an additional filter which is disposed at still another portion of the rotational movement body, whereby one of the dummy filter, the infrared ray filter and the additional filter is disposed at the first position according to the rotation of the rotational movement body,
wherein the additional filter is configured to block light having a given wavelength or has a smaller infrared blocking index than the infrared ray filter to block a portion of infrared rays.

11. A camera module comprising:
the image sensor module of the claim 1; and
a lens which is in the optical path.

12. The camera module of claim 12, further comprising a dummy filter which is at the first position if the infrared ray filter is at the second position, and is outside the optical path if the infrared ray filter is at the first position,
wherein the dummy filter transmits visible rays and infrared rays.

13. The camera module of claim 12, further comprising a controller which controls a voltage applied to the variable focus liquid crystal lens to change a focal length by changing a refractive index thereof.

14. The camera module of claim 13, wherein the controller controls the voltage applied to the variable focus liquid crystal lens to change the focal length by changing the refractive index thereof if the dummy filter is at the first position, and the controller does not control the voltage applied to the variable focus liquid crystal lens to change the focal length by changing the refractive index thereof if the infrared filter is at the first position.

15. The camera module of claim 14, wherein further comprising a driving unit which moves the infrared ray filter and the dummy filter between the first position and the second position by determining an amount of the light entering the image sensor.

16. The camera module of claim 14, further comprising an additional filter which is disposed at a third position if the infrared ray filter and the dummy filter are at the first and second positions or the second and first positions, respectively,
wherein the driving unit disposes one of the dummy filter, the infrared ray filter and the additional filter is disposed at the first position by determining an amount of the light entering the image sensor,
wherein the additional filter is configured to block light having a given wavelength or has a smaller infrared blocking index than the infrared ray filter to block a portion of infrared rays.

17. The camera module of claim 11, further comprising a rotational movement body which has a rotational center axis line in a direction substantially parallel with the optical path, and has a portion which is positioned at the first position or the second position as the rotational movement body rotates,
wherein the infrared ray filter is disposed at the portion of the rotational movement body.

18. The camera module of claim 17, further comprising a dummy filter which is disposed at another portion of the rotational movement body, whereby one of the dummy filter and the infrared ray filter is disposed at the first position according to the rotation of the rotational movement body.

19. The camera module of claim 18, further comprising an additional filter which is disposed at still another portion of the rotational movement body, whereby one of the dummy filter, the infrared ray filter and the additional filter is disposed at the first position according to the rotation of the rotational movement body,
wherein the additional filter is configured to block light having a given wavelength or has a smaller infrared blocking index than the infrared ray filter to block a portion of infrared rays.

20. A method of correcting a back focal length of a camera, the method comprising:
allowing an infrared ray filter to be disposed in or outside an optical path of incident light which enters an image sensor, wherein the infrared ray filter, decreases am amount of an infrared ray comprised in the incident light; and
if a focus of the incident light is changed as the infrared ray filter is disposed in or outside the optical path, adjusting a focal length of the incident light by changing a focal length of a variable focus liquid crystal lens disposed in the optical path of the incident light, whereby the focus of the incident light is positioned on the image sensor.
